(19) United States
(12) Patent Application Publication
(10) Pub. No.: US 2014/0189563 A1
(43) Pub. Date: Jul. 3, 2014

(54) PORTABLE DEVICE AND METHOD OF CONTROLLING USER INTERFACE

(71) Applicant: LG ELECTRONICS INC., Seoul (KR)

(72) Inventor: Jihwan KIM, Seoul (KR)

(73) Assignee: LG ELECTRONICS INC., Seoul (KR)

(21) Appl. No.: 13/791,292

(22) Filed: Mar. 8, 2013

(30) Foreign Application Priority Data
Dec. 31, 2012 (KR) 10-2012-0158323

(51) Int. Cl. G06F 3/0481

(52) U.S. Cl. CPC G06F 3/0481
USPC 715/771

(57) ABSTRACT

A portable device and a method for controlling a user interface (UI) of the same are disclosed. A method for controlling a user interface (UI) of a portable device includes: checking a pollution level of the portable device using at least one of place information and time information of the portable device; displaying pollution information of the portable device on a display unit through a user interface (UI) according to the checked pollution level of the portable device; detecting whether or not the portable device is washed; and if washing of the portable device is detected, stepwise-changing portable device's pollution information denoted by the user interface (UI) in response to a cleaning degree of the portable device.

Pursuant to 35 U.S.C. §119(a), this application claims the benefit of Korean Patent Application No. 10-2012-0158323, filed on Dec. 31, 2012, which is hereby incorporated by reference as if fully set forth herein.

### BACKGROUND OF THE INVENTION

1. Field of the Invention

The present disclosure relates to a portable device, and more particularly to a portable device having a waterproof function and a method for controlling a user interface for use in the portable device.

2. Discussion of the Related Art

Generally, a portable device includes a personal digital assistant (PDA), a portable media player (PMP), an e-book, a navigation system, an MP3 player, a smartphone, etc. Most portable devices are designed to select/execute various icons displayed on the screen using a variety of input units. For example, the input units may include mechanical touching activated by pressure applied to a keypad interworking with a dome switch of a circuit board, and screen touching activated by capacitance, electromagnetic induction, resistance film, near field imaging (NFI), ultrasonic waves, or infrared rays.

The portable device is very vulnerable to water in the same manner as other electronic devices, such that it is impossible for a user who plays in a swimming pool or on a beach to carry the portable device, resulting in greater inconvenience of use. In case of rain or if the portable device falls into water, it is impossible to waterproof the portable device, such that there is a high possibility that the portable device will break, resulting in economic losses.

In order to solve the above problems, waterproof portable devices have recently been introduced to the market.

### SUMMARY OF THE INVENTION

Accordingly, the present disclosure is directed to a portable device and a method for controlling a user interface of the portable device that substantially obviate one or more problems due to limitations and disadvantages of the related art.

An object of the present disclosure is to provide a waterproof portable device and a method for controlling a user interface for use in the same.

Another object of the present disclosure is to provide a waterproof portable device for detecting a pollution level thereof, and informing a user of the detected pollution level using a user interface so as to direct the user to wash his or her hands or clean the portable device, and a method for controlling a user interface for use in the portable device.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method for controlling a user interface (UI) of a portable device includes: checking a pollution level of the portable device using at least one of place information and time information of the portable device; displaying pollution information of the portable device on a display unit of the portable device through a user interface (UI) according to the checked pollution level of the portable device; detecting whether or not the portable device is washed; and if washing of the portable device is detected, changing portable device's pollution information denoted by the user interface (UI) in response to a cleaning degree of the portable device.

The method may further include: checking the pollution level of the portable device using at least one of a sensor detecting germs or bacteria and a sensor detecting dust or bodily fluid.

The method may further include: checking the pollution level of the portable device on a basis of a pollution level of a user hand.

The checking of the pollution level may include checking the pollution level of the portable device through at least one of pollution information and weather information of known places.

The cleaning degree of the portable device may be detected on the basis of at least one of information as to whether the portable device is washed with water, information as to whether a cleanser or detergent is used, rotation or non-rotation of the portable device, the presence or absence of touch input action for the portable device, intensity of touch pressure of the portable device, a shaken or unshaken action of the portable device, and a washing time of the portable device.

Images for enabling a user to recognize a pollution level of the portable device may be displayed as pollution information of the portable device on the display unit of the portable device.

Reduction of resolution of the display unit of the portable device may be displayed as pollution information of the portable device.

A text for enabling a user to recognize a pollution level of the portable device may be displayed as pollution information of the portable device on the display unit of the portable device.

The method may further include: audibly outputting pollution information of the portable device in response to the checked pollution level of the portable device.

The method may further include: outputting pollution information of the portable device using an alarm sound in response to the checked pollution level of the portable device.

The method may further include: outputting an information message for inducing a user to wash hands using at least one of text, picture, and voice messages, when the portable device is washed.

The method may further include: if the pollution information is removed by washing of the portable device, outputting an information message for inducing a user to wash hands using at least one of text, picture, and voice messages.

In another aspect of the present disclosure, a portable device includes: a wireless communication unit for receiving at least one of place information and time information of the portable device; a controller for checking a pollution level of the portable device using at least one of the received place and time information of the portable device; and a display unit for displaying pollution information of the portable device through a user interface (UI) according to the checked pollution level of the portable device, wherein the controller detects whether or not the portable device is washed, and changes portable device's pollution information denoted by the user interface (UI) in response to a cleaning degree of the portable device upon washing completion of the portable device.

The controller may check the pollution level of the portable device through addition of at least one of pollution information and weather information of known places.

The wireless communication unit may include: a position information module for receiving place information of the portable device; a mobile communication module for receiving time information of the portable device; and a short-range communication module for receiving at least one of pollution information and weather information of known places of the portable device.

The controller may check the pollution level of the portable device using at least one of a sensor detecting germs or bacteria and a sensor detecting dust or bodily fluid.

The controller may check the pollution level of the portable device on the basis of a pollution level of a user hand.

The controller may detect the cleaning degree of the portable device on on basis of at least one of information as to whether the portable device is washed with water, information as to whether a cleanser or detergent is used, rotation or non-rotation of the portable device, the presence or absence of touch input action for the portable device, intensity of touch pressure of the portable device, a shaken or unshaken action of the portable device, and a washing time of the portable device.

The display unit may display pollution information of the portable device using images for enabling a user to recognize a pollution level of the portable device.

The display unit may display pollution information of the portable device through reduction of resolution of the display unit.

The display unit may display pollution information of the portable device using a text for enabling a user to recognize a pollution level of the portable device.

The portable device may further include: a audio output module for audibly outputting pollution information of the portable device in response to the portable device's pollution level checked by the controller.

The portable device may further include: an alarm unit for outputting pollution information of the portable device using an alarm sound in response to the portable device's pollution level checked by the controller.

The controller may output an information message for inducing a user to wash hands, when the portable device is washed.

If the pollution information is removed by washing of the portable device, the controller may output an information message for inducing a user to wash hands using at least one of the display unit and the audio output module.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is a block diagram illustrating constituent components of a smartphone among a plurality of portable devices according to an embodiment of the present disclosure.

FIG. 2 is a diagram illustrating that a waterproof smartphone, according to an embodiment of the present disclosure, falls into water.

FIG. 3 is a front view illustrating the smartphone of FIG. 2 according to an embodiment of the present disclosure.

FIG. 4(a) is an example of a map indicating the position of a smartphone to enable a user to recognize a pollution level of the smartphone on the basis of geographical information according to an embodiment of the present disclosure.

FIG. 4(b) is an example of a watch indicating a time of the smartphone to recognize a pollution level of the smartphone on the basis of time information according to an embodiment of the present disclosure.

FIGS. 5(a) to 5(c) illustrate examples of different pollution levels of a hand according to an embodiment of the present disclosure.

FIG. 6(a) exemplarily shows a method for informing a user of a pollution level of the smartphone by changing a user interface according to an embodiment of the present disclosure.

FIG. 6(b) exemplarily shows a method for washing the smartphone of FIG. 6(a) using a user hand.

FIGS. 7(a) to 7(d) illustrate examples in which a pollution level of the washed smartphone of FIG. 6(a) is changed within the predetermined steps and restored to an original normal state.

FIG. 8(a) exemplarily shows a method for informing a user of a pollution level of the smartphone by changing a user interface according to another embodiment of the present disclosure.

FIG. 8(b) exemplarily shows a method for washing the smartphone of FIG. 8(a) by a user hand.

FIGS. 9(a) to 9(d) illustrate examples in which a pollution level of the washed smartphone of FIG. 8(a) is changed within the predetermined steps and restored to an original normal state.

FIG. 10(a) exemplarily shows a method for informing a user of a pollution level of the smartphone by changing a user interface according to still another embodiment of the present disclosure.

FIG. 10(b) exemplarily shows a method for washing the smartphone of FIG. 10(a) by a user hand.

FIGS. 11(a) to 11(d) illustrate examples in which a pollution level of the washed smartphone of FIG. 10(a) is changed within the predetermined steps and restored to an original normal state.

FIG. 12 is a flowchart illustrating a method for controlling a user interface according to embodiments of the present disclosure.

FIG. 13 is a flowchart illustrating a method for controlling a user interface according to embodiments of the present disclosure.

FIG. 14 is a flowchart illustrating a method for controlling a user interface according to embodiments of the present disclosure.

FIG. 15 shows an example the order of hand washing and a method of hand washing using images and text data.

### DESCRIPTION OF SPECIFIC EMBODIMENTS

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure.

Prior to describing the present disclosure, it should be noted that most terms disclosed in the present disclosure are defined in consideration of functions of the present disclosure and correspond to general terms well known in the art, and can be differently determined according to intentions of those skilled in the art, usual practices, or introduction of new technologies. In some cases, a few terms have been selected by the applicant as necessary and will hereinafter be disclosed in the following description of the present disclosure. Therefore, it is preferable that the terms defined by the applicant be understood on the basis of their meanings in the present disclosure.

In association with the embodiments of the present disclosure, specific structural and functional descriptions are disclosed for illustrative purposes only and the embodiments of the present disclosure can be implemented in various ways without departing from the scope or spirit of the present disclosure.

While the present disclosure permits a variety of modifications and changes, specific embodiments of the present disclosure illustrated in the drawings will be described below in detail. However, the detailed description is not intended to limit the present disclosure to the described specific forms. Rather, the present disclosure includes all modifications, equivalents, and substitutions without departing from the spirit of the disclosure as defined in the claims.

In description of the present disclosure, the terms “first” and/or “second” may be used to describe various components, but the components are not limited by the terms. The terms may be used to distinguish one component from another component. For example, a first component may be called a second component and a second component may be called a first component without departing from the scope of the present disclosure.

Throughout the specification, when a certain part “includes” a certain element, it means that the part can further include other elements not excluding the other elements. Furthermore, the terms “unit” and “part” mean units which process at least one function or operation, which can be implemented by hardware, software, or combination of hardware and software.

A human hand is a part most frequently touching a variety of harmful bacteria. That is, various harmful bacteria can easily invade a human body through a user's hand, thereby causing food poising or a cold. Therefore, keeping hands clean is a safeguard against disease, and a habit of always keeping hands clean is of importance to health. Specifically, the older a user or person is, the higher the difficulty in correcting a bad habit. Habits formed in childhood can greatly influence the user's whole life. Therefore, it is very important for the user to make a habit of washing his or her hands from childhood.

In addition, the portable device is in contact with the user's saliva, face, or hand(s) so that it is contaminated with bodily fluid. In addition, assuming that the user carrying the portable device goes out for a picnic, the portable device may be contaminated with dust or other contaminants according to time spent in the corresponding place.

The present disclosure provides a waterproof portable device for directing the user to wash the portable device as well as to wash his or her hand(s). Hereinafter, the term “portable device” to be described later indicates a waterproof portable device for convenience of description and better understanding of the present disclosure.

Hereinafter, a method for checking a pollution level of the portable device, a method for informing a user of a check time of the pollution level of the portable device, and a method for informing the user of a pollution state of the checked portable device will be described with reference to various embodiments.

Although the present disclosure will disclose various embodiments using the smartphone from among various portable devices for convenience of description, it should be noted that the scope or spirit of the present disclosure is not limited thereto. In other words, the present disclosure can be applied to all kinds of portable devices including the smartphone.

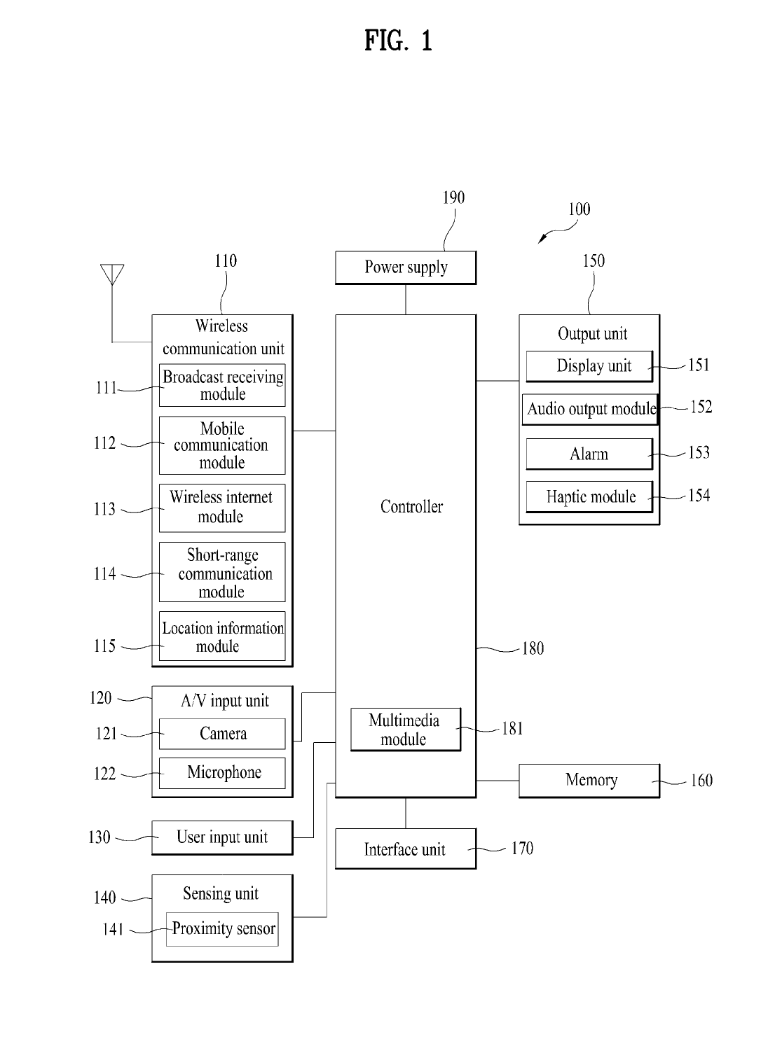

FIG. 1 is a block diagram illustrating a smartphone according to an embodiment of the present disclosure.

Referring to FIG. 1, the smartphone 100 may include a wireless communication unit 110, an A/V (Audio/Video) input unit 120, a user input unit 130, a sensing unit 140, an output unit 150, a memory 160, an interface unit 170, a controller 180, a power supply unit 190, etc. FIG. 1 illustrates the smartphone 100 having various components, but it is understood that implementing all of the illustrated components is not a requirement. The smartphone 100 may be implemented by greater or fewer components.

The wireless communication unit 110 includes one or more components allowing radio frequency (RF) communication between the smartphone 100 and a wireless communication system or a network in which the smartphone 100 is located. For example, the wireless communication unit 110 may include a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server via a broadcast channel.

The broadcast channel may include a satellite channel and/or a terrestrial channel. The broadcast management server may be a server (or a broadcast station) that generates and transmits a broadcast signal and/or broadcast associated information, or a server (or a broadcast station) that receives a previously generated broadcast signal and/or broadcast associated information and transmits the same to the smartphone. The broadcast signal may include a TV broadcast signal, a radio broadcast signal, a data broadcast signal, and the like. Also, the TV broadcast signal may further include a broadcast signal formed by combining the data broadcast signal with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive digital broadcast signals using various types of digital broadcast systems, for example, digital multimedia broadcasting-terrestrial (DMB-T), digital multimedia broadcasting-satellite (DMB-S), MediaFLO (Media Forward Link Only), digital video broadcast-handheld (DVB-H), integrated services digital broadcast-terrestrial (ISDB-T), mobile and handheld (MH), next generation handheld (NGH), etc. Of course, the broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160.

The mobile communication module 112 transmits and receives radio frequency (RF) signals to and from at least one of a base station (BS), an external terminal and a server. Such RF signals may include a voice call signal, a video call signal or various types of data according to text and/or multimedia message transmission and/or reception.

The wireless Internet module 113 supports wireless Internet access for the smartphone 100. This module may be internally or externally coupled to the smartphone 100. Here, as the wireless Internet technique, a wireless local area network (WLAN), Wi-Fi, wireless broadband (WiBro), world interoperability for microwave access (WiMAX), high speed downlink packet access (HSDPA), and the like, may be used.

The short-range communication module 114 is a module supporting short-range communication. Some examples of short-range communication technology include Bluetooth, Radio Frequency IDentification (RFID), Infrared Data Association (IrDA), Ultra-WideBand (UWB), ZigBee, and the like.

The location information module 115 is a module for checking or acquiring a location (or position) of the smartphone. For example, the location information module 115 may include a GPS (Global Positioning System) module that receives location information from a plurality of satellites.

The A/V input unit 120 is used to input an audio signal or a video signal and may include a camera module 121, a microphone 122, and the like. The camera module 121 processes an image frame of a still image or a moving image acquired through an image sensor in a video communication mode or an image capture mode. The processed image frame may be displayed on a display unit 151.

The image frame processed by the camera 121 may also be stored in the memory 160 or may be transmitted to the outside through the wireless communication unit 110. The camera 121 may include two or more camera modules 121 depending on use environments.

The microphone 122 receives an external sound(or audio) signal through a microphone and processes it into electrical audio data in a phone call mode or an audio recording mode, or a voice recognition mode. In the phone call mode, the processed audio data may be converted into a format transmittable to a base station (BS) through the mobile communication module 112. The microphone 122 may implement a variety of noise removal algorithms for removing noise occurring when receiving external sound signals.

The user input unit 130 generates key input data corresponding to key strokes that the user has entered for controlling the operation of the smartphone. The user input unit 130 may include a keypad, a dome switch, a touchpad (including a static-pressure type and an electrostatic type), a jog wheel, a jog switch, and the like.

The user input unit 130 includes a sensor (hereinafter referred to as a touch sensor) for sensing a touch gesture, and may be implemented as a touchscreen layered with the display unit 151. That is, the user input unit 130 may be integrated with the display unit 151 into one module. The touch sensor may be configured in the form of a touch film, a touch sheet, or a touchpad, for example.

The touch sensor may convert a variation in pressure, applied to a specific portion of the display unit 151, or a variation in capacitance, generated at a specific portion of the display unit 151, into an electric input signal. The touch sensor may sense pressure, position, and an area (or size) of the touch.

When the user applies a touch input to the touch sensor, a signal corresponding to the touch input may be transmitted to a touch controller (not shown). The touch controller may then process the signal and transmit data corresponding to the processed signal to the controller 180. Accordingly, the controller 180 may detect a touched portion of the display unit 151.

The user input unit 130 is designed to detect at least one of a user's finger and a stylus pen. The controller 180 can recognize at least one of the position, shape and size of the touched region according to the sensing result of the touch sensor contained in the user input unit 130.

The sensing unit 140 detects a current state of the smartphone 100 such as an open/closed state of the smartphone 100, location of the smartphone 100, acceleration or deceleration of the smartphone 100, and generates a sensing signal for controlling the operation of the smartphone 100. The sensing unit 140 also provides sensing functions associated with detection of whether or not the power-supply unit 190 supplies power or whether or not the interface unit 170 has been coupled with an external device. Meanwhile, the sensing unit 140 may include a proximity sensor 141. The sensing unit 140 may include a gyroscope sensor, an acceleration sensor, a geomagnetic sensor, etc.

The output unit 150 is provided to output an audio signal, a video signal, or a tactile signal and may include the display unit 151, an audio output module 152, an alarm unit 153, a haptic module 154, and the like.

The display unit 151 displays (outputs) information processed by the smartphone 100. For example, when the smartphone 100 is in a phone call mode, the display unit 151 may display a User Interface (UI) or a Graphical User Interface (GUI) associated with a call or other communication. When the smartphone 100 is in a video call mode or image capture mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like.

Some parts of the display unit 151 may be turned on or off. In more detail, the display unit 151 can be switched on or off in units of LEDs, and LEDs associated with a predetermined screen region can be switched on or off. In this case, the LEDs associated with the predetermined screen region may be LEDs for illuminating a light beam to the predetermined screen region or may be LEDs located at positions associated with the predetermined screen region. For example, the LEDs may be OLEDs. In addition, lighting of the screen region may indicate lighting of LEDs associated with the corresponding screen region, and brightness adjusting of the screen region may indicate brightness of LEDs associated with the corresponding screen region.

Power can be supplied to LEDs of the display unit 151 on the basis of the LEDs, or the amount of power supply of the display unit 151 is adjusted in units of LEDs, such that the LEDs can be turned on or off and brightness of the LEDs can be adjusted.

Some of these displays may be configured into a transparent type or light transmission type displays, through which the outside can be seen. These displays may be referred to as transparent displays. A representative of the transparent displays is a transparent OLED (TOLED). The rear structure of the display unit 151 may also be configured into a light transmission type structure. In this structure, it is possible for a user to view objects located at the rear of the smartphone body through a region occupied by the display unit 151 of the smartphone body.

Two or more display units 151 may be provided depending on how the smartphone 100 is realized. For example, the smartphone 100 may include both an external display unit (not shown) and an internal display unit (not shown). For example, a plurality of display units may be spaced apart from one surface of the smartphone 100 or be integrated in one. In addition, the display units may also be arranged at different surfaces, respectively.

If the display unit 151 and a sensor for sensing a touching action (hereinafter referred to as a touch sensor) are configured in the form of a layer, namely, if the display unit 151 and the touch sensor are configured in the form of a touchscreen, the display unit 151 may also be used as an input unit in addition to being used as the output unit. The touchscreen may be contained in the display unit 151, and the touch sensor may be contained in the user input unit 130.

A proximity sensor 141 may be disposed at an inner region of the smartphone 100 surrounded by the touchscreen or in the vicinity of the touchscreen. The proximity sensor 141 is a sensor to sense whether an object has approached a predetermined sensing surface or is present in the vicinity of the predetermined sensing surface using electromagnetic force or infrared rays without mechanical contact. The proximity sensor 141 has longer lifespan and higher applicability than a contact type sensor.

Examples of the proximity sensor 141 may include a transmission type photoelectric sensor, direct reflection type photoelectric sensor, mirror reflection type photoelectric sensor, high frequency oscillation type proximity sensor, capacitive type proximity sensor, magnetic type proximity sensor and infrared proximity sensor. In a case in which the touchscreen is of an electrostatic type, the touchscreen is configured to sense approach of a pointer based on change of an electric field caused by the approach of the pointer. In this case, the touchscreen (touch sensor) may be classified as a proximity sensor. In the following description, a physical unit (such as a user's finger or stylus pen) capable of performing touch, proximity touch, touch gesture, etc. will hereinafter be collectively referred to as a “pointer”.

In the following description, an action in which a pointer approaches the touchscreen without contact and it is recognized that the pointer is located on the touchscreen is referred to as “proximity touch”, and an action in which a pointer directly contacts the touchscreen is referred to as “contact touch” for convenience of description. A position at which proximity touch of the pointer is performed on the touchscreen is a position at which the pointer corresponds perpendicularly to the touchscreen when the proximity touch of the pointer is performed.

The proximity sensor 141 senses a proximity touch operation and proximity touch patterns (for example, a proximity touch distance, a proximity touch direction, proximity touch velocity, proximity touch time, a proximity touch position, proximity touch movement, etc.) Information corresponding to the sensed proximity touch operation and proximity touch patterns may be output on the touchscreen.

The audio output module 152 may output audio data which has been received from the wireless communication unit 110 or has been stored in the memory 160 during a call signal reception mode, a call connection mode, a recording mode, a voice recognition mode, a broadcast reception mode, and the like. The audio output module 152 may output audio (or sound) signals related to functions (e.g., call signal reception sound, message reception sound, etc.) carried out in the smartphone 100. The audio output module 152 may include a receiver, a speaker, a buzzer, and the like.

The alarm unit 153 outputs a signal notifying the user that an event has occurred in the smartphone 100. Examples of the event occurring in the smartphone 100 include incoming call reception, message reception, key signal input, touch input, etc. The alarm unit 153 outputs a signal notifying the user of the occurrence of an event in a different form from an audio signal or a video signal. For example, the alarm unit 153 may output a notification signal through vibration. The video signal or the audio signal may be output through the audio output module 152, so that the display unit 151 and the audio output module 152 may be classified as some parts of the alarm unit 153.

The haptic module 154 generates a variety of tactile effects which the user can sense. One typical example of the tactile effects that can be generated by the haptic module 154 is vibration. In a case where the haptic module 154 generates vibration as a tactile effect, the haptic module 154 may change intensity and pattern of generated vibration. For example, the haptic module 154 may combine different vibrations and output the combined vibration, or may sequentially output different vibrations.

In addition to vibration, the haptic module 154 may generate various tactile effects, such as a stimulus effect by an arrangement of pins that move perpendicularly to the touched skin surface, a stimulus effect by air blowing or suction through an air outlet or inlet, a stimulus effect through brushing of the skin surface, a stimulus effect through contact with an electrode, a stimulus effect using electrostatic force, and a stimulus effect through reproduction of thermal (cool/warm) sensation using an endothermic or exothermic element.

The haptic module 154 may be implemented so as to allow the user to perceive such effects not only through direct tactile sensation but also through kinesthetic sensation of fingers, arms, or the like of the user. Two or more haptic modules 154 may be provided depending on how the smartphone 100 is constructed.

The memory 160 may store a program for operating the controller 180, and may temporarily store I/O data (for example, a phonebook, a message, a still image, a moving image, etc.). The memory 160 may store vibration and sound data of various patterns that are output when a user touches the touchscreen.

The memory 160 may include a storage medium of at least one type of a flash memory, a hard disk, a multimedia card micro type, a card type memory (for example, SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disc, an optical disc, etc. Also, the smartphone 100 may utilize web storage that performs a storage function of the memory 160 over the Internet.

The interface unit 170 may be used as a path via which the smartphone 100 is connected to all external devices. The interface unit 170 receives data from the external devices, or receives a power-supply signal from the external devices, such that it transmits the received data and the power-supply signal to each constituent element contained in the smartphone 100, or transmits data stored in the smartphone 100 to the external devices. For example, the interface unit 170 may include a wired/wireless headset port, an external charger port, a wired/wireless data port, a memory card port, a port connected to a device including an identification module, an audio I/O port, a video I/O port, an earphone port, and the like.

An identification module is a chip that stores a variety of information for identifying the authority to use the smartphone 100, and may include a user identity module (UIM), a subscriber identity module (SIM), a universal scriber identity module (USIM), and the like. A device including an identification (ID) module (hereinafter referred to as an identification device) may be configured in the form of a smart card. Therefore, the ID device may be coupled to the smartphone 100 through a port.

When the smartphone 100 is connected to an external cradle, the interface unit 170 may be used as a path through which the connected cradle supplies power to the smartphone 100 or a path through which a variety of command signals input to the cradle by a user are transferred to the smartphone 100. The various command signals or the power input from the cradle may function as a signal for enabling the user to perceive that the mobile terminal is correctly mounted in the cradle.

The controller 180 generally controls the overall operation of the smartphone 100. For example, the controller 180 performs control and processing associated with voice communication, data communication, video communication, and the like. The controller 180 may include a multimedia module 181 for multimedia reproduction. The multimedia module 181 may be installed at the interior or exterior of the controller 180.

The controller 180 may sense a user action and control the smartphone 100 based on the sensed user action. The user action may include selection of a physical button of a display or a remote controller, implementation of a prescribed touch gesture or selection of a soft button on a touchscreen display, implementation of a prescribed spatial gesture recognized from an image captured from a capture device, and implementation of prescribed speaking recognized through voice recognition with respect to a voice signal received by the microphone 122. The controller 180 may interpret the user action as at least one implementable command. The controller 180 may control the components of the electronic device 400 in response to the at least one interpreted command. That is, the controller 180 may control input and output between the components of the smartphone 100 and reception and processing of data, using the at least one command.

The controller 180 can perform pattern recognition processing so as to recognize handwriting input or drawing input performed on the touchscreen as text and images.

The power supply unit 190 serves to supply power to each component by receiving external power or internal power under control of the controller 180.

A variety of embodiments to be disclosed in the following description may be implemented in a computer or a computer-readable recording medium by means of software, hardware, or a combination thereof.

In the case of implementing the present disclosure by hardware, the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electric units for implementing other functions, etc. In some cases, embodiments of the present disclosure may also be implemented as the controller 180.

In the case of implementing the present disclosure by software, embodiments such as steps and functions to be disclosed in the present disclosure can be implemented by additional software modules. Each software module may perform one or more functions and operations to be disclosed in the present disclosure. Software code can be implemented as a software application written in suitable program languages. The software code may be stored in the memory 160, and may be carried out by the controller 180.

The present disclosure checks a pollution level of the smartphone of FIG. 1 assuming that the smartphone of FIG. 1 has a waterproof function, informs the user of the checked pollution level of the smartphone using a user interface (UI), such that it can induce the user to wash the smartphone and his or her hands.

Specifically, the present disclosure has an object to provide a user interface for enabling users (e.g., kids) to enjoy washing the smartphone or hands with a lot of fun.

The embodiments of the present disclosure can detect a cleaning level of the smartphone on the basis of at least one of various information generated when the user washes the smartphone (for example, information as to whether the user washes the smartphone with water, information as to whether a cleanser or detergent is used, a washing time, intensity of touch pressure of the smartphone, rotation or non-rotation of the smartphone, the presence or absence of touch input (e.g., rubbing) action for the smartphone, a shaken or unshaken action of the smartphone, and positions touched by the user's hand), and can change smart-phone pollution level information displayed through a UI in response to the detected cleaning level, thereby correctly washing the smartphone.

Furthermore, the embodiments of the present disclosure can induce the user to simultaneously wash his or her hand and the smartphone using the UI.

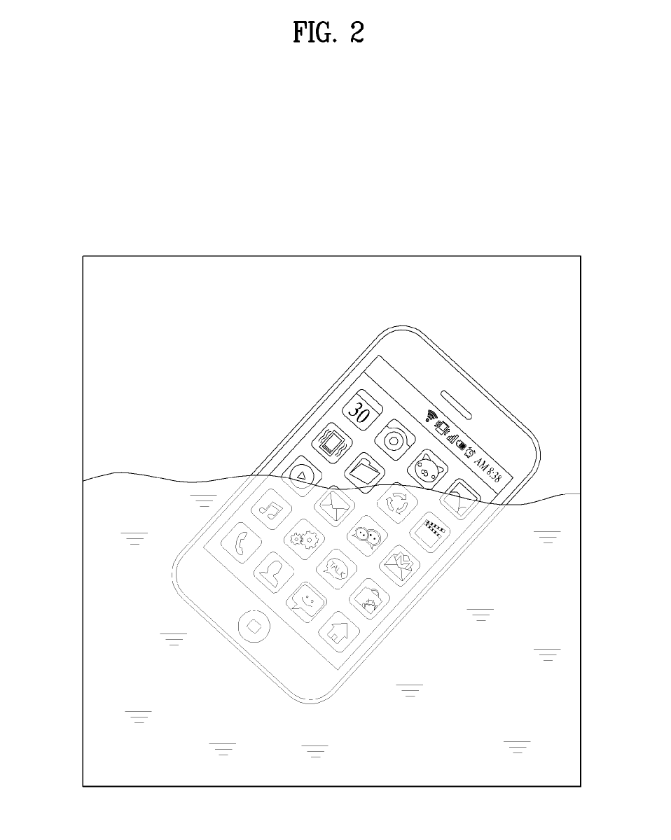

FIG. 2 is a diagram illustrating that a waterproof smartphone falls into water according to an embodiment of the present disclosure.

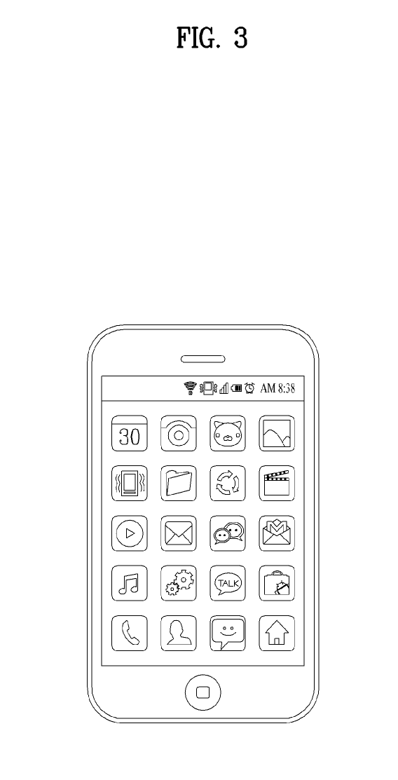

FIG. 3 is a front view illustrating the smartphone of FIG. 2 according to an embodiment of the present disclosure. Referring to FIGS. 2 and 3, the smartphone of FIG. 2 includes the display unit 151 and a bezel unit enclosing the display unit 151. The touchscreen of the display unit 151 includes a plurality of latticed icons, and the bezel unit may include a camera, a cancel button, a manufacturer logo, etc.

The embodiments of the present disclosure will hereinafter be described with reference to the smartphone of FIG. 3.

In accordance with the embodiments of the present disclosure, a pollution level of the smartphone can be checked using a variety of methods. For example, User Interface (UI) control for checking the pollution level of the smartphone and displaying the checked pollution level information may be realized by the controller 180. In another embodiment, a separate block is added to the block diagram of the smartphone shown in FIG. 1, and the added block may perform UI control for checking a pollution level of the smartphone and pollution information.

One embodiment of the present disclosure can indirectly check a pollution level of the smartphone using place information, time information, and pollution information of known places, and a detailed description thereof will hereinafter be referred to as a first embodiment.

The embodiment of the present disclosure can directly check a pollution level of the smartphone using sensors of the smartphone, and a detailed description thereof will hereinafter be referred to as a second embodiment.

The embodiment of the present disclosure can detect a pollution level of a user hand, and can check a pollution level of the smartphone on the basis of the detected pollution level of the hand, and a detailed description thereof will hereinafter be referred to as a third embodiment.

In accordance with the first embodiment, the controller 180 can indirectly check place information, time information, and pollution information of the known place. In addition, the controller 180 may use weather information indicating a weather condition of the corresponding date so as to indirectly check a pollution level of the smartphone. That is, the weather information may include an atmospheric condition, a dust level, the degree of wind, and the degree of impurities in the air.

Information used to indirectly check a pollution level of the smartphone can be easily added or deleted by a designer as necessary and, as such, the scope or spirit of the present disclosure is not limited to the above embodiments and can also be applied to other examples.

In this case, the place information indicates a location of a user carrying the smartphone, and the time information indicates time spent in the corresponding place. Pollution level information of the known places may be predetermined. For example, pollution level information of the known places may be pollution level information of a playground, a bathroom, a beach, a factory, a street, etc.

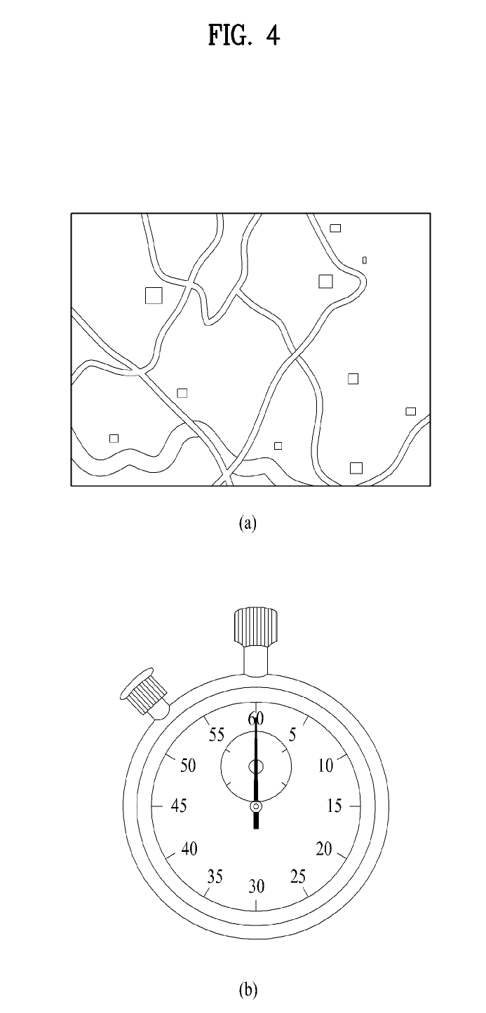

The controller 180 may obtain place information from the location information module 115. FIG. 4(a) is an example of a map indicating the position of a smartphone to enable a user to recognize a pollution level of the smartphone on the basis of geographical information. That is, it is possible to recognize of a current position of the user carrying the smartphone using a GPS module of the location information module 115. In other words, it is possible to recognize the scope of activity of the user carrying the smartphone.

In accordance with one embodiment of the present disclosure, the controller 180 can obtain time information from the mobile communication module 112. In other words, the mobile communication module 112 periodically receives weather information and time information from the base station (BS) of the corresponding communication company. FIG. 4(b) is an example of a watch indicating a current time of the smartphone to recognize a pollution level of the smartphone on the basis of time information from the mobile communication module 112. In other words, the controller 180 can recognize how long the user carrying the smartphone stays in a specific place using the mobile communication module 112 and the location information module 115. In addition, the controller 180 can also recognize how long the user carrying the smartphone goes out using the mobile communication module 112 and the location information module 115.

In accordance with one embodiment, the controller 180 can obtain pollution level information of the known places using the wireless Internet module 113. That is, the controller 180 can recognize pollution level information of a specific place in which the user carrying the smartphone stays using the wireless Internet module 113. In this case, the controller 118 may obtain pollution level information of known places by directly connecting to the Internet using the wireless Internet module 113. The pollution level information may be pre-downloaded to the memory unit 160 using the wireless Internet module 113, may also be read from the memory unit 160 as necessary, or may be prestored in the memory unit 160 in product fabrication.

In accordance with one embodiment, the controller 180 can obtain weather information of the corresponding date using the wireless Internet module 113. In other words, if a user connects to the wireless Internet using the wireless Internet module 113, the user can recognize weather conditions (e.g., dust and wind intensity) of the corresponding date. Specifically, the controller 180 can recognize the degree of dust of a specific region including the place in which the user stays for at least a predetermined time using the wireless Internet module 113 and the location information module 115.

In the first embodiment, the controller 180 can indirectly check a pollution level of the smartphone using at least one of place information, time information, pollution level information of known places, and weather information of the corresponding date.

For example, assuming that the user carrying the smartphone stays in a dusty place such as a playground for a long period of time, the controller 180 may determine a high pollution level of the smartphone.

In another example, assuming that the user carrying the smartphone stays in a dusty place such as a playground for a long period of time at a dust warning date, the controller 180 may determine an excessively high pollution level of the smartphone.

In accordance with the second embodiment, the controller 180 can directly check a pollution level of the smartphone using sensors of the smartphone. In this case, the sensor may be a sensor for detecting germs or bacteria, or a sensor for detecting dust or bodily fluid, etc. A plurality of sensors may be used to detect a pollution level of the smartphone. The capability of detecting a pollution level of the smartphone by the controller 180 may be changed according to categories and functions of the sensors.

In accordance with the third embodiment, the controller 180 can estimate a pollution level of the smartphone on the basis of a pollution level of a user hand. For example, after the user hand is captured by the camera 121, the controller 180 can check a pollution level of the hand on the basis of the captured information. In another embodiment, the controller 180 can check a pollution level of the hand using the scanner capable of detecting a level of hand pollution by scanning the user hand. In this case, the scanner may be embedded in the smartphone; or another scanner may also be used to transmit pollution level information of the hand using short-range wireless communication, such as Bluetooth, Radio Frequency Identification (RFID), infrared communication, Ultra Wideband (UWB), ZigBee, and the like. The hand pollution level information may also be received by the short-range communication module 114 of the smartphone, such that it can be provided to the controller 180. Since the user frequently touches the smartphones, the controller 180 determines that the smartphone is also contaminated in proportion to a pollution level of the hand.

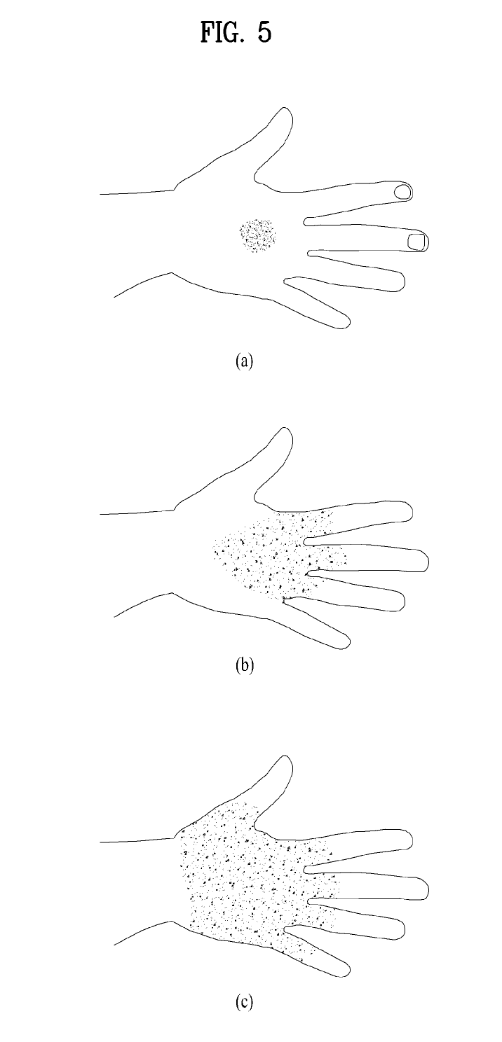

FIGS. 5(a) to 5(c) illustrate examples of different pollution levels of a hand. As can be seen from FIGS. 5(a) to 5(c), the hand of FIG. 5(b) has a higher pollution level than the hand of FIG. 5(a), and the hand of FIG. 5(c) has a higher pollution level than the hand of FIG. 5(b).

One embodiment of the present disclosure relates to a method for checking a pollution level of the smartphone using at least one of the first to third embodiments. That is, it is possible to check a pollution level of the smartphone using one of the first to third embodiments, it is possible to check a pollution level of the smartphone by combining the first embodiment with the second embodiment, it is possible to check a pollution level of the smartphone by combining the first embodiment with the third embodiment, it is possible to check a pollution level of the smartphone by combining the second embodiment with the third embodiment, and it is also possible to check a pollution level of the smartphone by combining the first to third embodiments.

In accordance with one embodiment, the controller 180 checks a pollution level of the smartphone when the user carrying the smartphone returns home. For this purpose, it is necessary to pre-register a reference place used for checking a pollution level of the smartphone. For convenience of description and better understanding of the present disclosure, a home may be registered as a reference place. In this case, the position information of the registered home is obtained from the location information module 115 and can also be registered. The reference place may also be changed by the user. That is, assuming that it is possible to measure how long the user carrying the smartphone comes out of the reference place, it is possible to recognize the user going-out.

In another embodiment, the controller 180 may determine a specific time such that it can check a pollution level of the smartphone at the determined time. It may be possible to check a pollution level of the smartphone at intervals of a predetermined time. Alternatively, it may also be possible to check a pollution level of the smartphone only upon receiving a user request. For these purposes, a function for switching a pollution level on or off may also be used as necessary.

In the meantime, the display unit 151 displays (or outputs) information processed by the smartphone. For example, if the smartphone is in a phone call mode, the display unit 151 may display a User Interface (UI) or a Graphical User Interface (GUI) associated with a call or other communication. When the smartphone 100 is in a video call mode or image capture mode, the display unit 151 may display a captured image and/or received image, a UI or GUI that shows videos or images and functions related thereto, and the like.

In accordance with one embodiment, if a pollution level of the smartphone is checked using the above-mentioned methods, the controller 180 may inform the user of pollution level information of the smartphone using the UI, such that it can induce the user to wash the smartphone and his or her hands.

The embodiments of the present disclosure can inform the user of a pollution level of the smartphone using a variety of UIs.

For example, at least one of an image (for example, spotted image) indicating a pollution level of the smartphone, and a text indicating the pollution level of the smartphone is determined to be pollution level information of the smartphone, so that the determined one may be displayed on the display unit 151. Alternatively, resolution of the display unit 151 is reduced and then displayed as pollution level information of the smartphone. More specifically, the pollution level information of the smartphone may be represented as if the display unit 151 of the smartphone were contaminated with spots or foreign substances, may be represented as if icons of the display unit 151 were contaminated with dust, or may also be represented as if icons remain unchanged and only a background image were dirty. In addition, the pollution level information of the smartphone may be represented by the dimming degree of icons, and the display unit 151 may be dimmed to indicate such pollution level information of the smartphone. The User Interface (UI) may be represented to indicate the reason of pollution of the smartphone (or hand). For example, if the corresponding place is a playground, the UI may be represented by sand. If the corresponding place is a muddy-air space, the UI may be represented by dust. If the smartphone is contaminated with much dust, the UI may be represented by bacteria. If the smartphone is contaminated with bodily fluid of a user face, the UI may be represented by oil shape. In addition, the display unit 151 may be represented in a rugged or rough manner, a button of the smartphone may be embedded in a manner that the button cannot be pressed by the user, or the smartphone button function is released in a manner that the corresponding function is not activated even when the button is pressed by the user. In addition, the UI indicating a pollution level of the smartphone may be represented by pager beeping sound from the alarm unit 153, and an audio or voice signal indicating pollution of the smartphone may be output from the audio output module 152. In this case, an audio or voice signal indicating pollution of the smartphone may be output, and/or other voice signal indicating the reason of pollution of the smartphone may be further output as necessary. In addition, the audio output module 152 may further output another voice signal for directing the user to wash his or her smartphone. Alternatively, sensitivity of the microphone module 122 may be reduced or resolution of the camera module 121 may be reduced in such a manner that the user may feel as if the smartphone were superannuated. In addition, the smartphone may be vibrated using the haptic module 154. That is, UIs for enabling the user to check a pollution level of the smartphone can be applied to the embodiments of the present disclosure.

For convenience of description and better understanding of the present disclosure, pollution information denoted by UI may be changed according to a pollution level of the smartphone. For example, assuming that the display unit 151 is represented as if it were contaminated with spots, more spots may be displayed in proportion to increasing pollution.

One embodiment of the present disclosure describes that pollution information denoted by the UI is changed within the predetermined steps when the user washes the smartphone, and is then restored to an original normal state. Specifically, the change of pollution information denoted by UI and a recovery time needed for the UI restored to a normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input (e.g., rubbing) action for the smartphone, a shaken or unshaken action of the smartphone, and positions touched by the user's hand. For example, assuming that the display unit 151 is represented as if it were contaminated with spots, the spots are gradually reduced and disappear, rather than being simultaneously removed.

In addition, the embodiments of the present disclosure can induce the user to wash his or her hands using the display unit 151 or the audio output module 152 when the user washes the smartphone or the UI of the smartphone is restored to an original normal state. For example, an information message such as “Please wash your hands” may be provided using at least one of a text message and a voice message. In another example, a method for washing the user hands may be provided to the user through at least one of text, picture, and voice messages.

In accordance with one embodiment of the present disclosure, when pollution information of the smartphone is notified to the user using at least one of the above-mentioned methods, if the user does not perform any action (specifically, washing of the smartphone) for a predetermined time, the smartphone can be automatically restored to an original normal state. In this case, the predetermined time may be changed by the user as necessary.

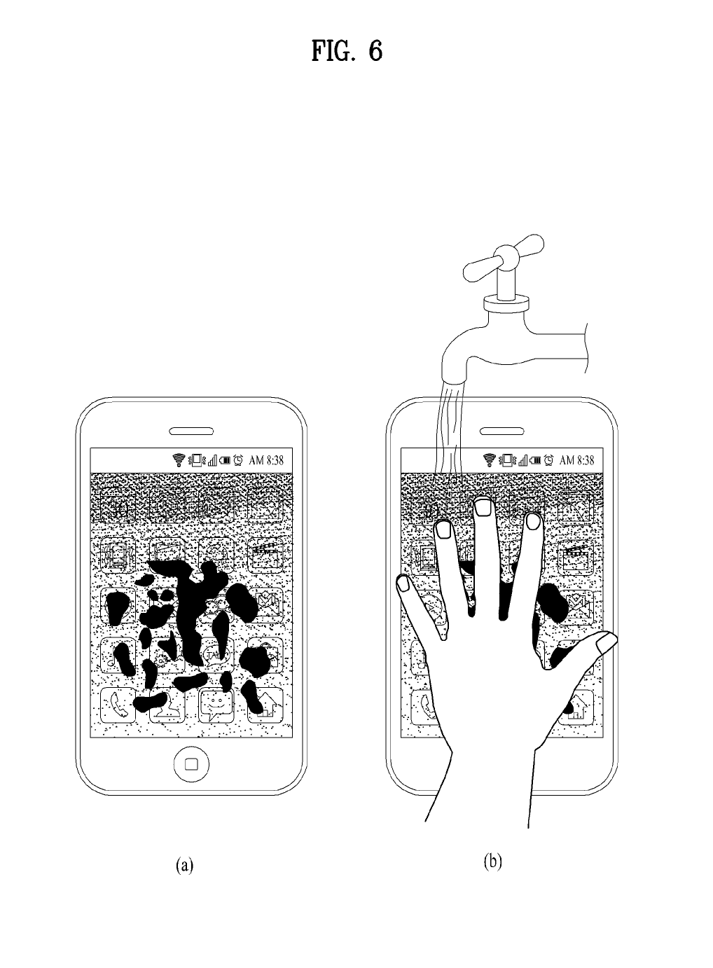

FIG. 6(a) shows an exemplary method for displaying pollution information of the smartphone on the display unit 151 using the user interface (UI). FIG. 6(b) shows an exemplary method for washing the smartphone of FIG. 6(a) using a user hand. In other words, FIG. 6(a) shows a method for indicating a pollution level of the smartphone using appearance of the display unit 151 strained with spots or foreign materials. In this case, the amount or size of spots or foreign materials displayed on the display unit 151 may be changed according to the checked pollution level of the smartphone.

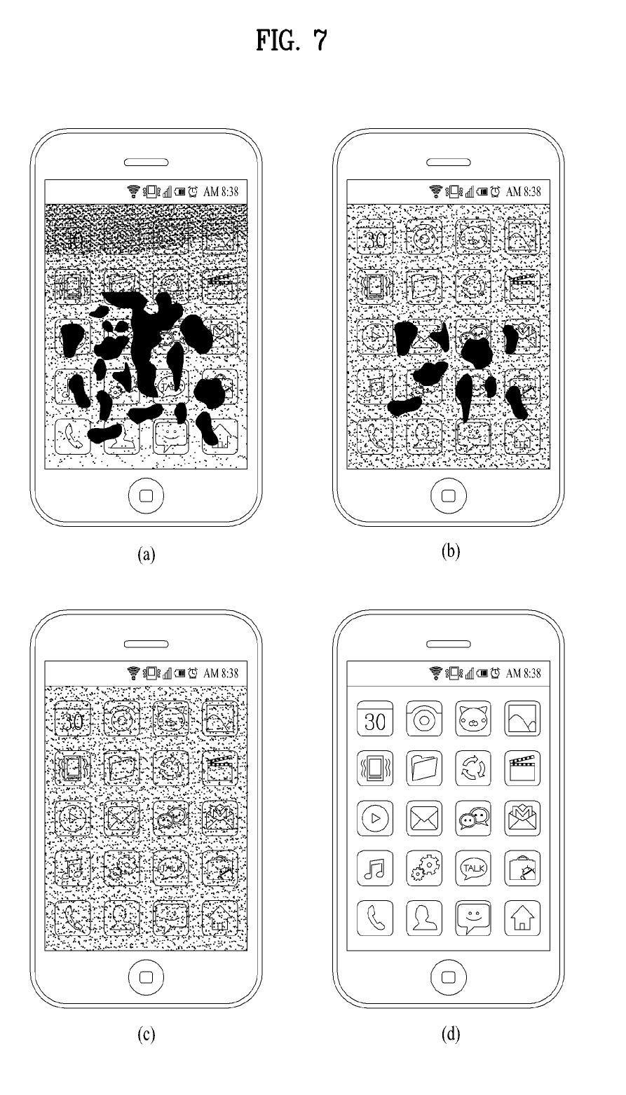

FIGS. 7(a) to 7(d) illustrate examples in which a pollution level of the smartphone denoted by the UI as shown in FIG. 6(a) is changed within the predetermined steps such that the display unit 151 is restored to an original normal state. That is, as can be seen from FIG. 7(a), much more spots are displayed on the display unit 151 so that the user can recognize the increased pollution level of the smartphone. In this case, if the smartphone is washed with water, spots displayed on the display unit 151 are gradually reduced in number as can be seen from FIGS. 7(b) and 7(c), and the display unit 151 is restored to an original normal state as can be seen from FIG. 7(d). In this case, the change of pollution information displayed on the display unit 151 and a recovery time needed for the display unit 151 to revert to a normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input (e.g., rubbing) action for the smartphone, a shaken or unshaken action of the smartphone, and positions touched by the user's hand.

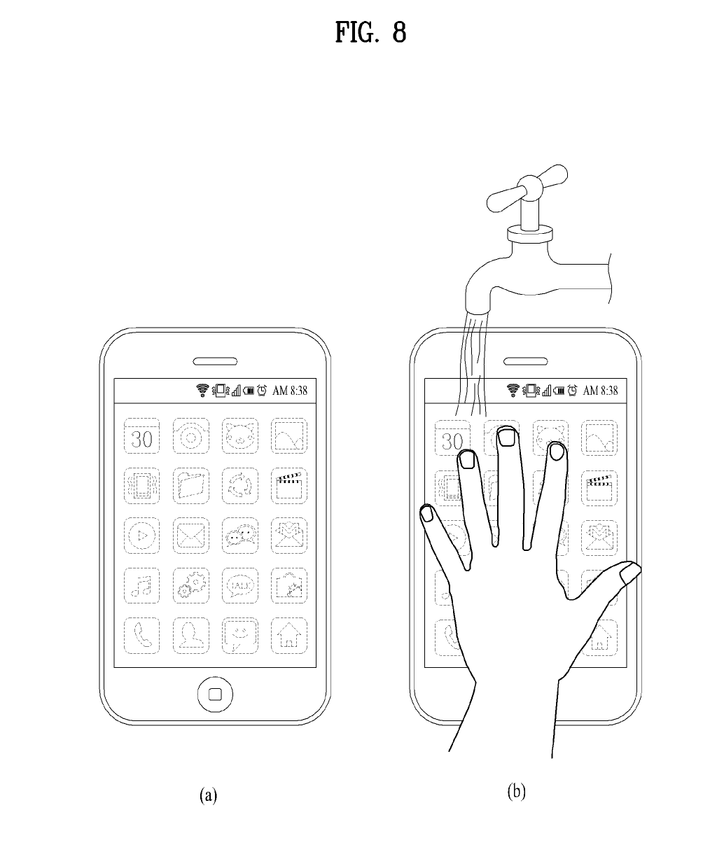

FIG. 8(a) shows another method for displaying pollution information of the smartphone on the display unit 151 using the user interface (UI). FIG. 8(b) shows an exemplary method for washing the smartphone of FIG. 8(a) using a user hand. In more detail, FIG. 8(a) shows that icons of the display unit 151 are dimmed to indicate a pollution level of the smartphone. In this case, the dimming degree of icons may be changed according to the checked pollution level of the smartphone. In another example, icons may be displayed as black-and-white icons indicating pollution of the smartphone.

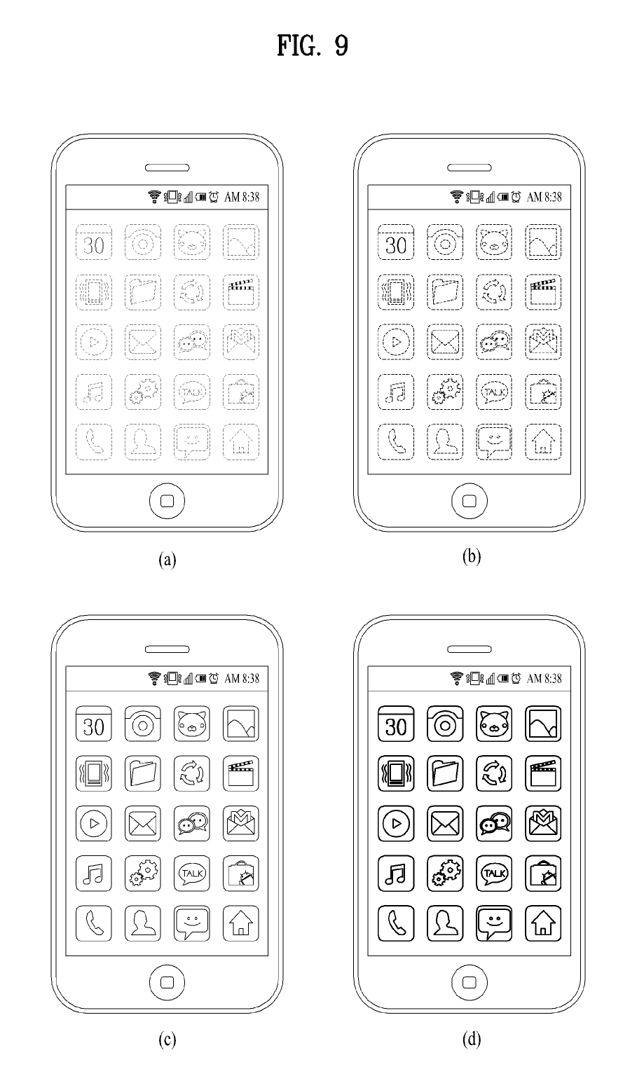

FIGS. 9(a) to 9(d) illustrate examples in which a pollution level of the smartphone denoted by the UI as shown in FIG. 8(a) is changed within the predetermined steps such that the display unit 151 is restored to an original normal state. That is, as can be seen from FIG. 9(a), icons of the display unit 151 are heavily dimmed to indicate a high pollution level of the smartphone. In this case, if the smartphone is washed with water, icons are more distinctly displayed as shown in FIGS. 9(b) and 9(c), and icons of the display unit 151 are restored to an original normal state as can be seen from FIG. 9(d). In this case, the change of pollution information displayed on the display unit 151 and a recovery time needed for the display unit 151 to revert to a normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input (e.g., rubbing) action for the smartphone, a shaken or unshaken action of the smartphone, and positions touched by the user's hand.

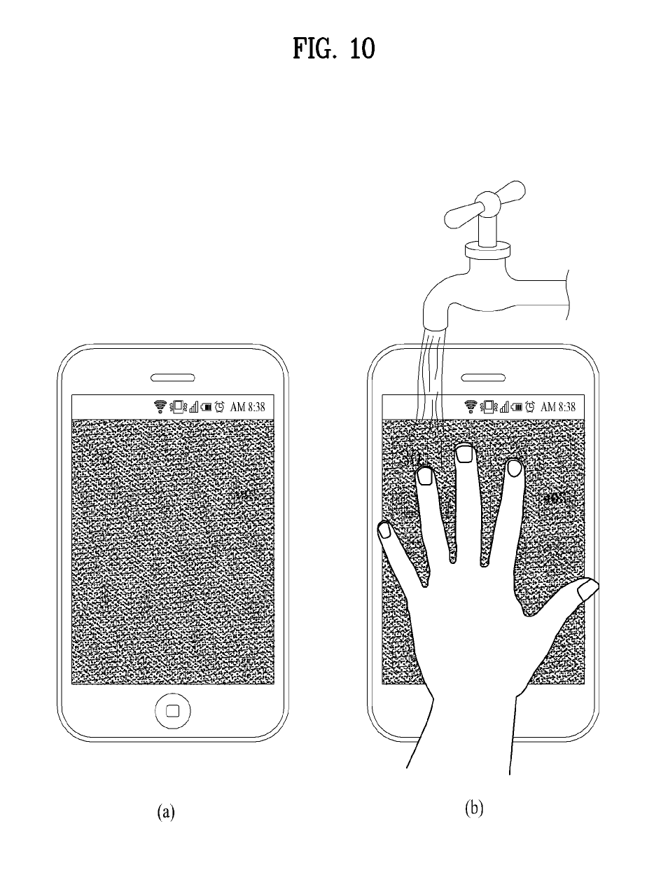

FIG. 10(a) shows another method for displaying pollution information of the smartphone on the display unit 151 using the user interface (UI). FIG. 10(b) shows an exemplary method for washing the smartphone of FIG. 8(a) using a user hand. In more detail, FIG. 10(a) shows that the display unit 151 is dimmed to indicate a pollution level of the smartphone. In this case, the dimming degree of the display unit 151 may be changed according to the checked pollution level of the smartphone. That is, assuming that the smartphone is seriously contaminated, the display unit 151 is heavily dimmer so that icons of the display unit 151 may disappear.

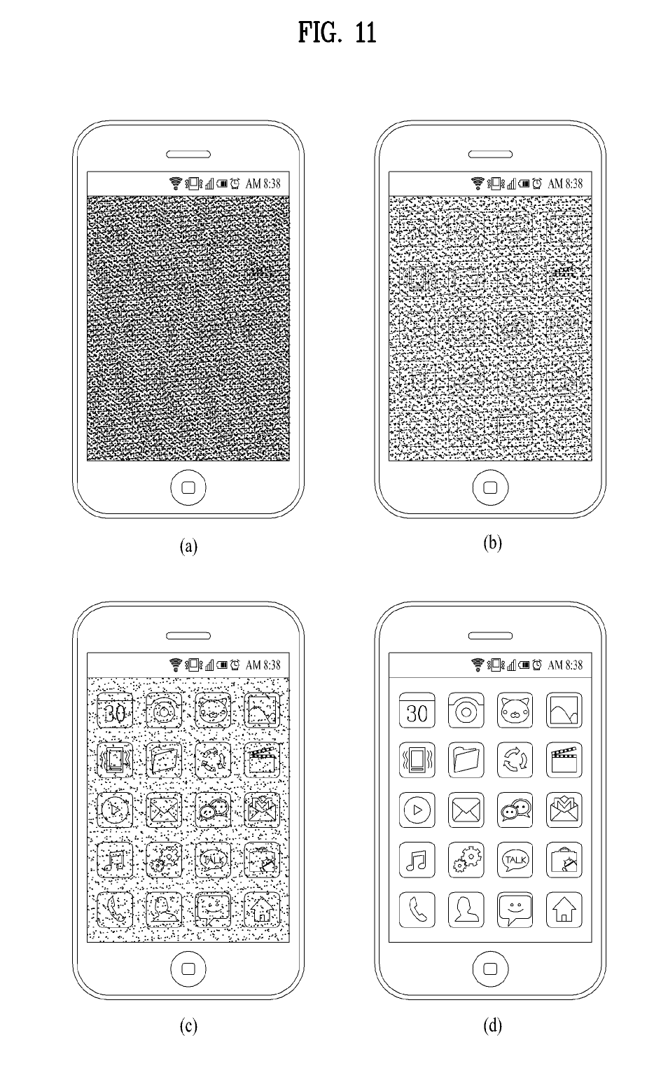

FIGS. 11(a) to 11(d) illustrate examples in which smartphone pollution information denoted by a UI of FIG. 10(a) is changed within the predetermined steps and restored to an original normal state. That is, FIG. 11(a) displays the display unit 151 covered with much dust so as to indicate a high pollution level of the smartphone. In this case, if the smartphone is washed with water, the dimming degree of the display unit 151 is gradually reduced as shown in FIGS. 11(b) and 11(c), and the display unit 151 is restored to an original normal state as shown in FIG. 11(d). In this case, the change of pollution information displayed on the display unit 151 and a recovery time needed for the display unit 151 to revert to a normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input (e.g., rubbing) action for the smartphone, a shaken or unshaken action of the smartphone, and positions touched by the user's hand.

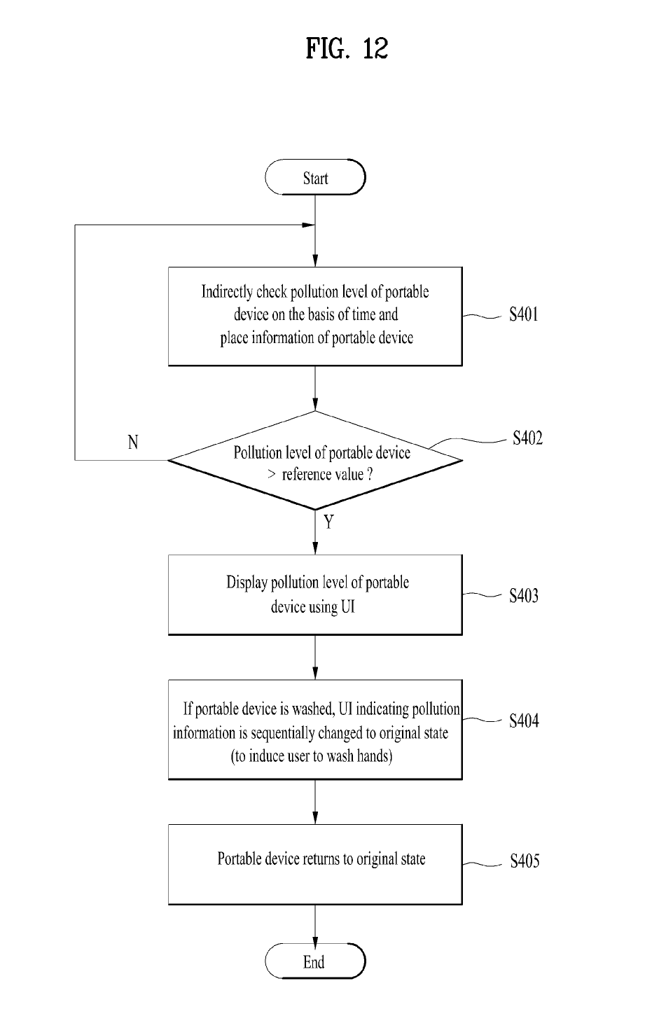

FIG. 12 is a flowchart illustrating a method for controlling a user interface according to embodiments of the present disclosure. Specifically, FIG. 12 is a flowchart illustrating a method for controlling a user interface (UI) when a pollution level of the portable device is indirectly detected using the first embodiment of the present disclosure.

That is, a pollution level of the portable device is checked on the basis of a place including the user carrying the portable device and a user-stay time in the corresponding place in step S401. In this case, pollution information of known places and weather information of the corresponding date can be used to check a pollution level of the portable device. In this case, the embodiment of the present disclosure can check a pollution level of the portable device using at least one of place information, time information, pollution information of known places, and weather information of the corresponding date, a detailed description thereof is identical to those of the first embodiment, and as such a detailed description will be omitted for convenience of description.

If a pollution level of the portable device is checked in step S401, it is determined whether the checked pollution level of the portable device is higher than a reference pollution level in step S402. Pollution level information of the portable device can be notified to the user in step S403 only when the checked pollution level of the portable device is higher than the reference pollution level. The reason why the pollution level of the portable device is notified to the user only when the pollution level of the portable device is higher than the reference pollution level is to increase user convenience. That is, the portable device can be easily contaminated. Assuming that the embodiment induces the user to wash his or her smartphone under a negligible pollution level, the user may feel inconvenienced.

A method for displaying pollution level information of the portable device in step S403 may use the user interface (UI) of the display unit 151, or may use the audio output module 152 or the alarm unit 153. For example, pollution information of the portable device can be notified to the user by displaying spots on the display unit 151 as shown in FIG. 6, and icons of the display unit 151 are very dimly displayed to inform the user of a pollution level of the portable device as shown in FIG. 8. In another example, the display unit 151 is displayed with much dust as shown in FIG. 10 so as to inform the user of pollution level information of the portable device. That is, various methods for informing the user of pollution level information of the portable device have already been disclosed above, and as such a detailed description will be omitted for convenience of description.

After pollution level information of the portable device is notified to the user in step S403, if the user washes the portable device with water, the UI indicating a pollution level state is sequentially changed within the predetermined steps in step S404 and is then restored to an original normal state in step S405.

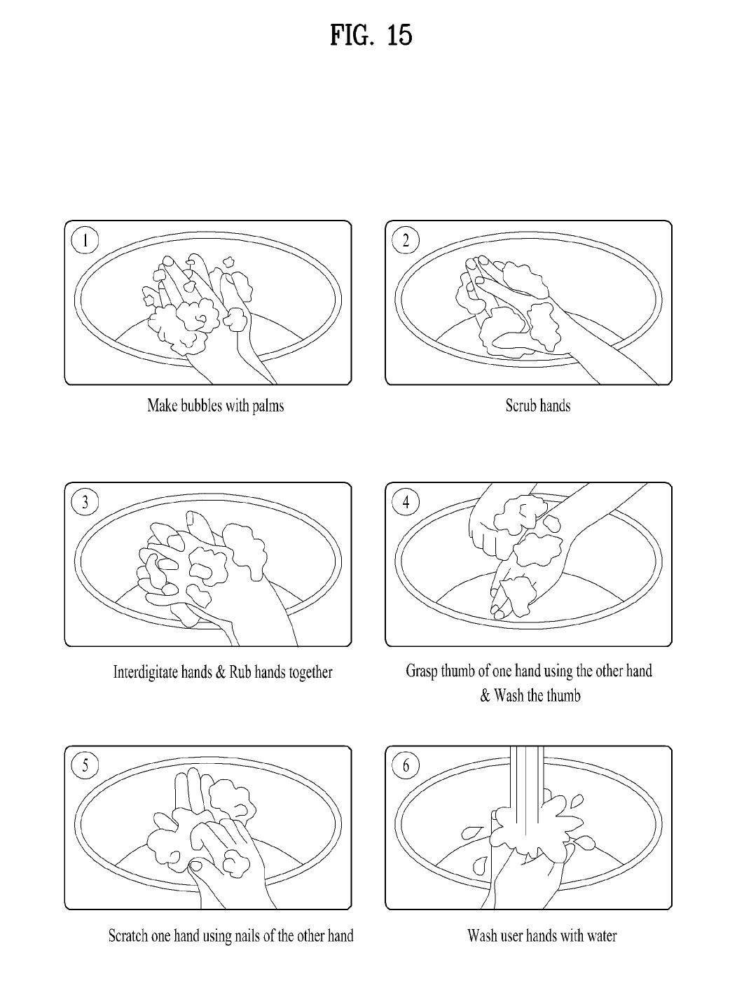

In step S404, the change of pollution information denoted by the UI and a recovery time needed for the UI to revert to an original normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input action for the smartphone, a shaken or unshaken action of the smartphone, and positions touched by the user's hand. When the portable device is washed with water or the UI of the portable device is restored to an original normal state through washing of the portable device in steps S404 and S405, the embodiments of the present disclosure can further induce the user to wash his or her hands using the display unit 151 or the audio output module 152. For example, an information message such as “Please wash your hands” may be provided using at least one of a text message and a voice message. In another example, a method for washing the user hands may be provided to the user through at least one of text, picture, and voice messages. FIG. 15 shows an example of hand washing and a method of hand washing using images and text data. Such images and text may be displayed on the display unit 151 of the portable device, and associated information thereof may be audibly output through the audio output module 152.

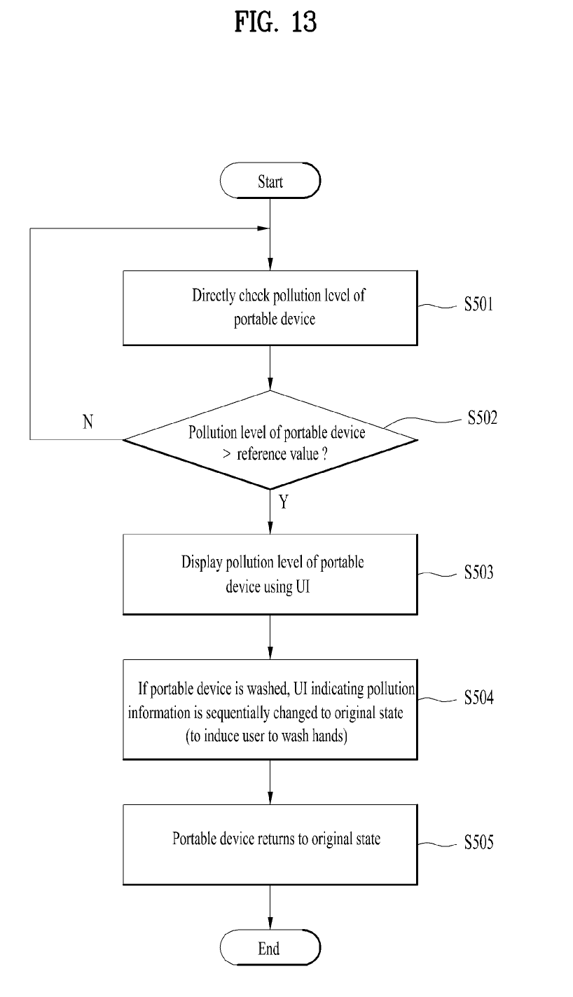

FIG. 13 is a flowchart illustrating a method for controlling a user interface according to embodiments of the present disclosure. Specifically, FIG. 13 is a flowchart illustrating a UI control method when a pollution level of the portable device is directly detected using the second embodiment of the present disclosure.

That is, a pollution level of the portable device is detected using at least one sensor embedded in the portable device in step S501. A detailed description of the method for detecting a pollution level of the portable device using at least one sensor is identical to those of the second embodiment, and as such a detailed description thereof will be omitted for convenience of description.

If a pollution level of the portable device is checked in step S501, it is determined whether the checked pollution level of the portable device is higher than a reference pollution level in step S502. Pollution level information of the portable device can be notified to the user in step S503 only when the checked pollution level of the portable device is higher than the reference pollution level.

A method for displaying pollution level information of the portable device in step S503 may use the user interface (UI) of the display unit 151, or may use the audio output module 152 or the alarm unit 153. For example, pollution information of the portable device can be notified to the user by displaying spots on the display unit 151 as shown in FIG. 6, and icons of the display unit 151 are very dimly displayed to inform the user of a pollution level of the portable device as shown in FIG. 8. In another example, the display unit 151 is displayed with much dust as shown in FIG. 10 so as to inform the user of pollution level information of the portable device. That is, various methods for informing the user of pollution level information of the portable device have already been disclosed above, and as such a detailed description thereof will be omitted for convenience of description.

After pollution level information of the portable device is notified to the user in step S503, if the user washes the portable device with water, the UI indicating a pollution level state is sequentially changed within the predetermined steps in step S504 and is then restored to an original normal state in step S505.

In step S504, the change of pollution information denoted by UI and a recovery time needed for the UI to revert to an original normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input action for the smartphone, a shaken or unshaken action of the smartphone, and positions touched by the user's hand. When the portable device is washed with water or the UI of the portable device is restored to an original normal state through washing of the portable device in steps S504 and S505, the embodiments of the present disclosure can further induce the user to wash his or her hands using the display unit 151 or the audio output module 152. For example, an information message such as “Please wash your hands” may be provided using at least one of a text message and a voice message. In another example, a method for washing the user hands may be provided to the user through at least one of text, picture, and voice messages. FIG. 15 shows an example of hand washing and a method of hand washing using images and text data. Such images and text may be displayed on the display unit 151 of the portable device, and associated information thereof may be audibly output through the audio output module 152.

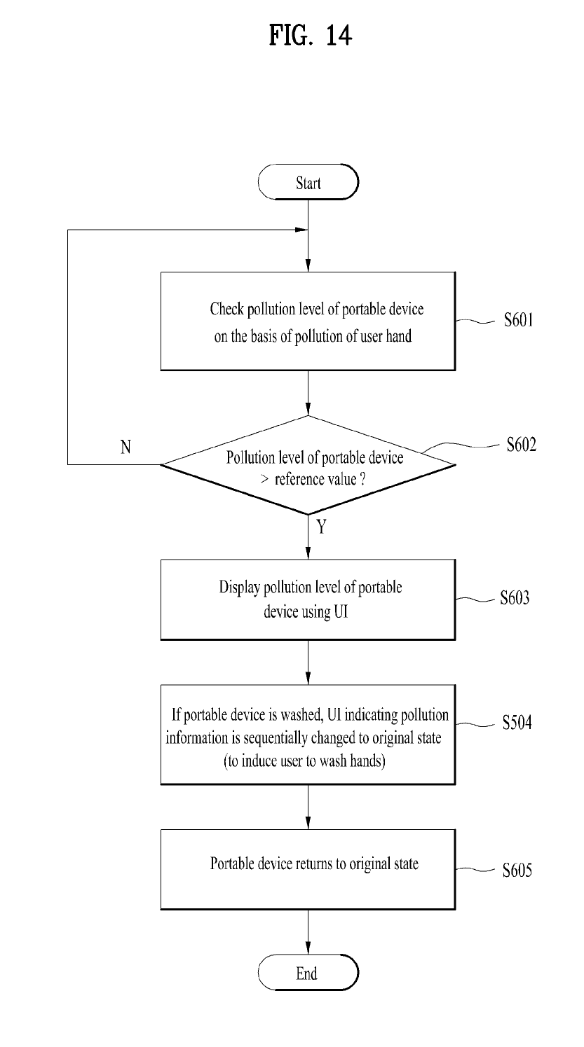

FIG. 14 is a flowchart illustrating a method for controlling a user interface (UI) according to embodiments of the present disclosure. Specifically, FIG. 14 is a flowchart illustrating a UI control method when a pollution level of the portable device is directly detected using the third embodiment of the present disclosure.

That is, a pollution level of the hand is checked using the camera or scanner embedded in the portable device, and a pollution level of the portable device is checked on the basis of the detected hand pollution level in step S601. In another embodiment, after the pollution level of the hand is checked using a separate scanner, and the checked pollution level may be provided to the portable device using short-range wireless communication, such as Bluetooth, Radio Frequency Identification (RFID), infrared communication, Ultra Wideband (UWB), ZigBee, and the like. A method for detecting a pollution level of the portable device using the checked hand pollution result is identical to those of the third embodiment, and as such a detailed description thereof will be omitted for convenience of description.

If a pollution level of the portable device is checked in step S601, it is determined whether the checked pollution level of the portable device is higher than a reference pollution level in step S602. Pollution level information of the portable device can be notified to the user in step S603 only when the checked pollution level of the portable device is higher than the reference pollution level.

A method for displaying pollution level information of the portable device in step S603 may use the user interface (UI) of the display unit 151, or may use the audio output module 152 or the alarm unit 153. For example, pollution information of the portable device can be notified to the user by displaying spots on the display unit 151 as shown in FIG. 6, and icons of the display unit 151 are very dimly displayed to inform the user of a pollution level of the portable device as shown in FIG. 8. In another example, the display unit 151 is displayed with much dust as shown in FIG. 10 so as to inform the user of pollution level information of the portable device. That is, various methods for informing the user of pollution level information of the portable device have already been disclosed above, and as such a detailed description thereof will be omitted for convenience of description.

After pollution level information of the portable device is notified to the user in step S603, if the user washes the portable device with water, the UI indicating a pollution level state is sequentially changed within the predetermined steps in step S604 and is then restored to an original normal state in step S605.

In step S604, the change of pollution information denoted by UI and a recovery time needed for the UI to revert to an original normal state can be determined on the basis of various information, for example, information as to whether the user washes the smartphone with water, information as to whether a cleanser or detergent is used, a washing time, intensity of touch pressure of the smartphone, rotation or non-rotation of the smartphone, the presence or absence of touch input action for the smartphone, a shaken or unshaken action of the smartphone, and positions touched by the user's hand. When the portable device is washed with water or the UI of the portable device is restored to an original normal state through washing of the portable device in steps S604 and S605, the embodiments of the present disclosure can further induce the user to wash his or her hands using the display unit 151 or the audio output module 152. For example, an information message such as “Please wash your hands” may be provided using at least one of a text message and a voice message. In another example, a method for washing the user hands may be provided to the user through at least one of text, picture, and voice messages. FIG. 15 shows an example of hand washing and a method of hand washing using images and text data.

As is apparent from the above description, the portable device and a method for controlling a user interface (UI) according to the embodiments of the present disclosure have the following advantages. A pollution level of the portable device is checked, a user interface (UI) of the portable device is changed to inform the user of a pollution level of the portable device, such that it is possible to educate or induce the user carrying a waterproof portable device to wash his or her hands. Specifically, although washing hands for kids has been greatly emphasized by teachers, most kids are apt to forget to wash their hands upon returning home, but this problem can be solved by the above-mentioned embodiments for enabling kids to enjoy washing the smartphone or hands without forgetting. In other words, the UI of the smartphone according to the present disclosure induces a kid who comes home from a playground, an amusement park or a kindergarten to wash their hands, such that the kid can enjoy washing the smartphone or their hands.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A method for controlling a user interface (UI) of a portable device, the method comprising:
checking a pollution level of the portable device using at least one of place information and time information of the portable device;
displaying pollution information of the portable device on a display unit of the portable device through a user interface (UI) according to the checked pollution level of the portable device;
detecting whether or not the portable device is washed; and
if washing of the portable device is detected, changing portable device's pollution information denoted by the user interface (UI) in response to a cleaning degree of the portable device.

2. The method according to claim 1, further comprising:
checking the pollution level of the portable device using at least one of a sensor detecting germs or bacteria and a sensor detecting dust or bodily fluid.

3. The method according to claim 1, further comprising:
checking the pollution level of the portable device on a basis of a pollution level of a user hand.

4. The method according to claim 1, wherein checking the pollution level of the portable device further includes checking the pollution level of the portable device through at least one of pollution information and weather information of known places.

5. The method according to claim 1, wherein the cleaning degree of the portable device is detected on the basis of at least one of information as to whether the portable device is washed with water, information as to whether a cleanser or detergent is used, rotation or non-rotation of the portable device, the presence or absence of touch input action for the portable device, intensity of touch pressure of the portable device, a shaken or unshaken action of the portable device, and a washing time of the portable device.

6. The method according to claim 1, wherein images for enabling a user to recognize a pollution level of the portable device are displayed as pollution information of the portable device on the display unit of the portable device.

7. The method according to claim 1, wherein reduction of resolution of the display unit of the portable device is displayed as pollution information of the portable device.

8. The method according to claim 1, wherein a text for enabling a user to recognize a pollution level of the portable device is displayed as pollution information of the portable device on the display unit of the portable device.

9. The method according to claim 1, further comprising:
audibly outputting pollution information of the portable device in response to the checked pollution level of the portable device.

10. The method according to claim 1, further comprising:
outputting pollution information of the portable device using an alarm sound in response to the checked pollution level of the portable device.

11. The method according to claim 1, further comprising:
outputting an information message for inducing a user to wash hands using at least one of text, picture, and voice messages, when the portable device is washed.

12. The method according to claim 1, further comprising:
if the pollution information is removed by washing of the portable device, outputting an information message for inducing a user to wash hands using at least one of text, picture, and voice messages.

13. A portable device comprising:
a wireless communication unit configured to receive at least one of place information and time information of the portable device;
a controller configured to check a pollution level of the portable device using at least one of the received place and time information of the portable device; and
a display unit configured to display pollution information of the portable device through a user interface (UI) according to the checked pollution level of the portable device,
wherein the controller detects whether or not the portable device is washed, and changes portable device pollution information denoted by the user interface (UI) in response to a cleaning degree of the portable device upon washing completion of the portable device.

14. The portable device according to claim 13, wherein the controller checks the pollution level of the portable device through addition of at least one of pollution information and weather information of known places.

15. The portable device according to claim 14, wherein the wireless communication unit includes:
a position information module configured to receive place information of the portable device;
a mobile communication module configured to receive time information of the portable device; and
a short-range communication module configured to receive at least one of pollution information and weather information of known places of the portable device.

16. The portable device according to claim 13, wherein the controller checks the pollution level of the portable device using at least one of a sensor detecting germs or bacteria and a sensor detecting dust or bodily fluids.

17. The portable device according to claim 13, wherein the controller checks the pollution level of the portable device on the basis of a pollution level of a user hand.

18. The portable device according to claim 13, wherein the controller detects the cleaning degree of the portable device on a basis of at least one of information as to whether the portable device is washed with water, information as to whether a cleanser or detergent is used, rotation or non-rotation of the portable device, the presence or absence of touch input action for the portable device, intensity of touch pressure of the portable device, a shaken or unshaken action of the portable device, and a washing time of the portable device.

19. The portable device according to claim 13, wherein the display unit displays pollution information of the portable device using images for enabling a user to recognize a pollution level of the portable device.

20. The portable device according to claim 13, wherein the display unit displays pollution information of the portable device through reduction of resolution of the display unit.

21. The portable device according to claim 13, wherein the display unit displays pollution information of the portable device using a text for enabling a user to recognize a pollution level of the portable device.

22. The portable device according to claim 13, further comprising:
an audio output module configured to audibly output pollution information of the portable device in response to the portable device's pollution level checked by the controller.

23. The portable device according to claim 13, further comprising:
an alarm unit configured to output pollution information of the portable device using an alarm sound in response to the portable device's pollution level checked by the controller.

24. The portable device according to claim 22, wherein the controller outputs an information message for inducing a user to wash hands, when the portable device is washed.

25. The portable device according to claim 22, wherein the controller, if the pollution information is removed by washing of the portable device, outputs an information message for inducing a user to wash hands using at least one of the display unit and the audio output module.
